(19) United States
(12) Patent Application Publication
(10) Pub. No.: US 2004/0028241 A1
(43) Pub. Date: Feb. 12, 2004

(54) Audio data recorder

(75) Inventor: Achim Gleissner, Barienrode (DE)

Correspondence Address: Gerald H. Kiel, Esq., REED SMITH LLP, 599 Lexington Avenue, New York, NY, 10022-7650, US

(73) Assignee: Sennheiser electronic GmbH & Co. KG;

(21) Appl. No.: 10/627,169

(22) Filed: Jul. 25, 2003

(30) Foreign Application Priority Data
Jul. 26, 2002 (DE) 102 34 066.8

(51) Int. Cl. H04R 1/02; H04R 3/00

(52) U.S. Cl. 381/91; 381/122

(57) ABSTRACT

The invention relates to an audio data recorder. The invention is based on the problem that built-in microphones of the type above-mentioned do not ensure adequate sound quality and that, on the other hand, additional microphones connected by cable are only inadequately suitable in practice as the recording appliance and the microphone unit are often not precisely tuned to one another. In the solution according to the invention the microphone or the microphone unit and the recording appliance (audio data recorder) are connected to one another via a plug connection not only electrically, but also mechanically rigidly, wherein they may preferably be separable without additional tools. A microphone with a recording unit connected thereto in accordance with the invention for recording the signals generated by a microphone transducer of the microphone, wherein the recording unit and the microphone are connected to one another via a detachable plug connection and the signals generated by the microphone transducer via the plug connection are transmitted to the recording unit.

### CROSS-REFERENCE TO RELATED APPLICATION

This application claims priority of German Application No. 102 34 066.8, filed Jul. 26, 2002, the complete disclosure of which is hereby incorporated by reference.

### BACKGROUND OF THE INVENTION

a) Field of the Invention

The invention relates to an audio data recorder.

b) Description of the Related Art

Recorders of this type are already known in diverse form and design, for example as a dictating system, recording cassette recorder or other recording machines. Thus, for example, recording appliances in analogous form are known as magnetic tape recording appliances, wherein in such appliances, if they are designed as dictating appliances or portable cassette recorders, the microphone unit holding the electro-acoustic microphone transducer is either fixedly built-in or can be connected by a cable plug connection. Recording appliances storing the audio data signals in digital form, in which the microphone unit is also a fixed component of the appliance, such as for example in digital speech memories (telephones with answering machines) and digital dictating appliances (for example Philips Pocket Memo Digital 9300) are also known.

In digital dictating appliances of this type, the audio data stored on a media card (RAM, Flash etc.) and can be downloaded therefrom for further processing.

Digital recording appliances are also known of the type which have the possibility of connecting an additional microphone for recording. This microphone is then connected with conventional commercial connectors via cable.

The invention is based on the problem that built-in microphones of the above-mentioned type do not ensure adequate sound quality and that, on the other hand, additional microphones connected by cable are only inadequately suitable in practice as the recording appliance and the microphone unit are often not precisely tuned to one another.

### OBJECT AND SUMMARY OF THE INVENTION

The primary object of the invention is to overcome the stated problems with prior devices. This is achieved, in accordance with the invention, in a microphone device which comprises a microphone having a microphone transducer and a recording unit for recording signals generated by the microphone transducer of the microphone. The recording unit and the microphone are connected to one another via a detachable plug connection and the signals generated by the telephone are transmitted to the recording unit via the plug connection.

In the solution according to the invention the microphone or the microphone unit and the recording appliance (audio data recorder) are connected to one another via a plug connection, not only electrically but also mechanically rigidly, wherein they are preferably separable without additional tools.

The separating point here between the microphone unit and the recording appliance may be located visibly between the two units or may be located invisibly from the outside within a common housing.

It is certainly possible for the recording appliance to also be designed with an interface for further transmission of the stored audio data to a receiver. This may be an infrared interface, a RF interface or else an HF interface here or else a mobile radio part (mobile phone) coupled to the recording appliance or integrated therein, with which recorded audio data can be transmitted to a predetermined receiver.

A XLR plug connection is preferably formed between the recording unit and the microphone unit. This has the advantage that the recording unit can be coupled together with practically any desired microphones, because an XLR connector is generally formed as the preferred embodiment in the case of microphones.

If hardware and software are available in the recording appliance for data reduction of the audio data, it is also possible to record the audio data on the data memory of the recording appliance in a data-reduced format, for example MP3, MPEG audio layer 2, ADPCM or combinations thereof.

In the process, in the transducer principle used in the microphone there is no particular restriction, dynamic microphones can also be used in the above-described form and can be plugged together with the microphone recording unit.

The invention will be described in more detail hereinafter with the aid of two alternative embodiments.

### BRIEF DESCRIPTION OF THE DRAWINGS

In the drawings:

FIG. 1 shows a schematic diagram of a recording unit according to the invention with a microphone unit attached thereto; and

FIG. 2 shows a alternative embodiment to FIG. 1.

### DESCRIPTION OF THE PREFERRED EMBODIMENTS

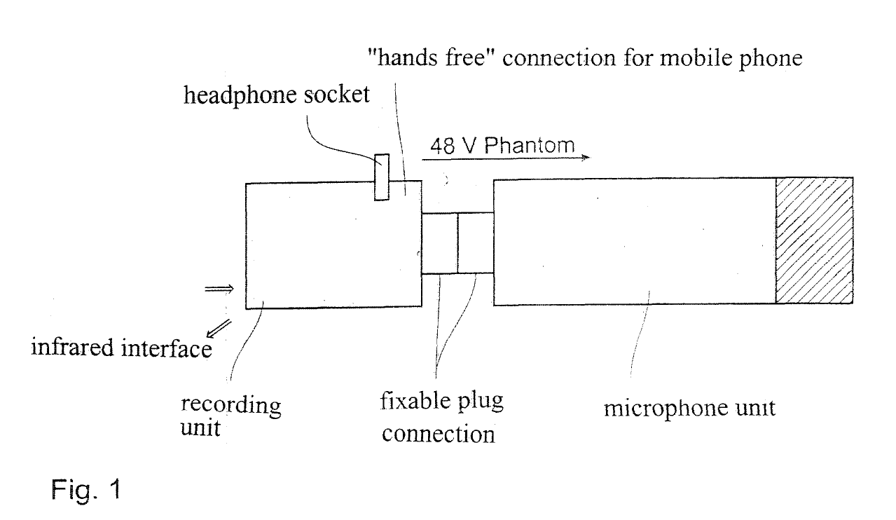

FIG. 1 shows a microphone unit 1 containing a microphone transducer and the electric circuits generally arranged in a microphone for processing and relaying the electric (or optical) signal as a carrier for the audio data. The microphone unit 1 is rigidly connected to a recording unit 3 via a fixable plug connection 2, i.e. there is not only an electrical connection between the microphone unit and the recording unit, but both parts are also mechanically rigidly connected to one another via the connection in such a way that the mechanical position relative to one another remains unchanged.

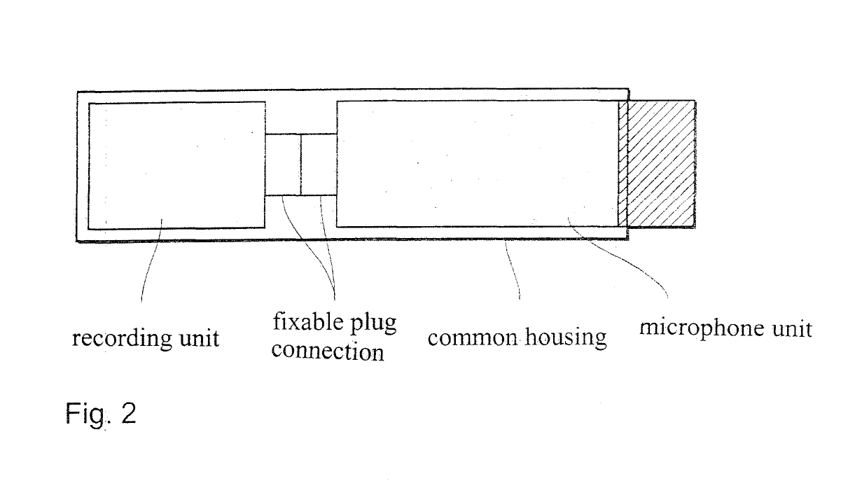

FIG. 2 shows an alternative embodiment, the connection, on the one hand, and also the recording unit being a part of the microphone unit and the plug connection, on the other hand, being invisible owing to a surrounding housing 6.

This form has the particular advantage, that the outer configuration is very attractive and also it is possible to manufacture a microphone from which it is not initially assumed that it also has a recording unit, wherein an aesthetically uniform design for the various parts connected to one another via the plug connection can be created owing to the common housing.

Basically, the microphone unit 1 shown may be a standard microphone, in other words a microphone which has hitherto been available commercially, but which has a correspondingly good mechanical and electrically reliable plug connection, for example an XLR plug connection, so the microphone unit 1 and the recording unit 3 can be connected to one another via the XLR plug connection, so on the one hand, an electrically adequate connection is provided between the two parts, but, on the other hand, the two parts are also adequately rigidly fixed to one another mechanically.

As many microphones with cables also have an XLR plug connection, microphones with cables can therefore also be used, wherein these are connected with their connector not to a cable, but to the recording unit which, in turn, must then provide the necessary energy (energy store) for operation of the microphone and also for the recording and other operation.

Apart from an energy store (battery), the recording unit also contains the data memory for storing the audio signals, wherein this may be a hard disc or another known data memory including a digital semiconductor memory (flash) or a media card. Moreover the recording unit is provided with an interface, by means of which the recorded audio signal data can be relayed to the receiver. This interface may be an infrared interface, an RF interface, an HF interface or else a mobile radio interface, so on appropriate use, recorded audio data signals can be relayed, completely or in part, via elements which may be formed on the recording unit.

The recorded audio signal data can even be relayed when the microphone recording operation is still in process, in other words audio signals are still being recorded or stored in the recording unit via the microphone.

The recording unit is preferably provided with a headphone socket or a socket for connecting a mobile radio headset, so the reporter using the microphone according to the invention also always knows which audio data signals he is recording and in certain circumstances he can also transmit cue instructions by speaking into the mouthpiece of the headset on a parallel track. If the recording unit is connected to a conventional mobile radio telephone (mobile phone) or if this is also integrated into the recording unit, the reporter can also simultaneously receive cue instructions from a studio center via the mobile radio headset and allow suitable questions and remarks for the interview being carried out to flow in therefrom. Primarily, with the relay via mobile radio to the studio center already being used, it can also be checked very quickly whether the recording is technically in order and the studio center simultaneously has the possibility via the microphone input of the reporter's headset, of understanding the content of the reporter's interview partner and can immediately react thereto with corresponding cue instructions to the reporter.

It is absolutely possible that relaying of already recorded audio data signals takes place with a smaller data transmission (for example 68 kbit/sec), than the signal rate at which the recording itself takes place (for example 100 kbit/sec).

The recording unit is preferably also equipped with a device for phantom power supply (for example 48V phantom power supply) for the microphone unit, to thus also allow the connection of microphones which generally have cables via their XLR interface of the recording unit.

In the embodiment according to FIG. 2, if necessary, further batteries can also be accommodated in the housing, or outside the recording unit, so an adequate electric energy store is available overall, to also carry out longer recordings.

Various possibilities are conceivable for the recording unit, for example a recording unit in the form of a solid memory, a writeable disc, flashRAM etc.

The microphone unit and the recording unit cannot only be connected to one another by means of a fixable plug connection in the form of a XLR plug connection, but also via an XLR cable. It is easily possible here that the information in the recording unit can also be transmitted to corresponding receiving units via a cable connection, telephone line or the like. It is also of particular advantage here if the information flow is scaleable.

The recording unit may be provided with a connection for a mobile telephone or with a hands free modem for a mobile telephone. The recording unit may also simultaneously provide the phantom power supply for the microphone unit (48 volt) or be equipped with an infrared interface or have a socket for a headphone, so the person using the microphone also simultaneously hears what is spoken into the microphone.

While the foregoing description and drawings represent the present invention, it will be obvious to those skilled in the art that various changes may be made without departing made therein without departing from the true spirit and scope of the present invention.

What is claimed is:

1. A microphone device, comprising:
a microphone having a microphone transducer; and
a recording unit for recording signals generated by the microphone transducer of the microphone;
said recording unit and said microphone being connected to one another via a detachable plug connection and the signals generated by the microphone transducer being transmitted to the recording unit via the plug connection.

2. The microphone according to claim 1, wherein the plug connection between the recording unit and the microphone is an XLR plug connection.

3. The microphone according to claim 1, wherein means for data reduction are formed in the recording unit and wherein the audio signals are recorded with a data-reduced format.

4. The microphone according to claim 1, wherein an interface is formed in the recording unit for wireless transmission of recorded audio signals.

5. The microphone according to claim 1, wherein a headphone socket is formed in the recording unit, by which the audio signal recorded by the microphone is audible.

6. The microphone according to claim 1, wherein the recording unit can be connected to a mobile telephone and has appropriate connection devices for this purpose and a mobile telephone/headset can be connected to the recording unit and/or the mobile telephone.

7. The microphone according to claim 6, wherein audio signals recorded by the recording unit are transmitted via the mobile telephone at a signal rate which is lower or higher than the recording data rate and wherein transmission to the mobile telephone can preferably already be started, while audio signals are picked up by the microphone and are recorded and stored by the recording unit.
